(19) United States
(12) Patent Application Publication
(10) Pub. No.: US 2006/0185203 A1
(43) Pub. Date: Aug. 24, 2006

(54) Portable illuminated real estate sign system

(76) Inventors: Ivy Rene Bittle, Brooklyn, NY (US); Evans Emmanuel Joseph, Brooklyn, NY (US)

Correspondence Address: Ivy R. Bittle, P.O. Box 150-388, Brooklyn, NY, 11215-0388, US

(21) Appl. No.: 11/341,183

(22) Filed: Jan. 28, 2006

Related U.S. Application Data
(60) Provisional application No. 60/648,944, filed on Jan. 31, 2005.

(51) Int. Cl. G09F 13/00

(52) U.S. Cl. 40/541; 40/607.09

(57) ABSTRACT

The portable illuminated real estate sign system consists of a carrying case, a sign, and a post. This solar powered illuminated sign is attached to a detachable post that has an anti-theft device. An accompanying bag is used for ease of transport and storage. The sign can be single- or double-sided, having a weatherproof casing, a plastic transparent front and back, and a hinged door to allow signage to be easily changed. Within the sign casing is a solar panel that collects solar energy to charge at least one rechargeable battery, energizing light sources to be turned on by a light sensor from dusk till dawn.

### CROSS REFERENCE TO RELATED APPLICATIONS

This application is claiming the benefit and filing date of Jan. 31, 2005 previously filed provisional application with the application No. 60/648,944.

### FEDERALLY SPONSORED RESEARCH

Not Applicable

### SEQUENCE LISTING

Not Applicable

### FIELD OF INVENTION

This invention relates generally to illuminated signs. More particularly it pertains to an improved portable illuminating real estate outdoor sign, accompanying sign post, carrying bag, and the like. Also a method of using said portable illuminating real estate outdoor sign and accompanying sign post.

### BACKGROUND OF THE INVENTION

The present invention relates to a marketing tool such as a “for sale” sign used in the real estate industry to advertise a property available for sale or rent, or any business that has a need for a portable outdoor sign for advertisement. The real estate business typically uses a yard sign for advertising purposes, placed in front of a property containing the real estate company's name, telephone number(s), real estate broker's or agent's name, etc. Most of the signs are made from a sheet of plastic material, such as polyethylene. These signs are not illuminated.

In light of this problem inventors created illuminated real estate signs. The need for an illuminated real sign has been addressed in U.S. Patent Office Class 362/183, 340/571, 40/564, 40/559, and 40/572 showing a number of different illuminated signs that can be used for the real estate industry and the like. Some of these patents have devices that are difficult and timely to install, the sign post is not detachable or able to be unassembled for easy transportation, poor lighting, unattractive appearance and cumbersome assembly, partly on during dusk to dawn, and without an anti-theft deterrent. In fact, these same drawbacks are also associated with many of the other related classes of selective illumination display devices, which are known in the prior art. Due to these drawbacks there is a need for an improved illuminated sign and accompanying post. The present invention overcomes the disadvantages of the prior art by providing a complete portable illuminating real estate outdoor sign, accompanying sign post, and carrying bag.

### BRIEF SUMMARY OF THE INVENTION

Accordingly an object of the invention is to provide an improved portable illuminating real estate sign in the form of a real estate advertising system which is easy to carry, assemble, install, and dismantle. Also a system having reduced vulnerability to vandalism and theft. This system is capable of providing a better visible view of a real estate advertisement from dusk till dawn by potential buyers walking or driving by the property.

Another object of the invention is to provide an illuminating aesthetically pleasing double sided or single display of transparency advertisements in the form of a picture frame consisting of a real estate company's name, telephone number(s), broker's or agent's name, and other related information.

Yet another objective of the invention is to provide signage that allows flexibility with which to change the transparency advertisements easily without having to reconstruct the sign or purchase a new sign.

A further objective and advantage of the invention is to provide an increase in calls by potential buyers viewing the sign during cloudy conditions or from dusk till dawn in order to increase the sale of property for real estate professionals and home owners.

Further, another object of the present invention is to provide a portable, lightweight, inexpensive, durable, detachable, accompanying sign post that can easily be disassembled for transporting or storage.

Another object of the invention is the optional use of a mounting assembly on back of the casing of the single sided sign to facilitate being hung from prior art sign posts.

Other features and advantages of the present invention will be improved security and stability provided by locking devices allowing the casing as well as the post to be locked and locked to a permanent device like a fence.

Another object of the invention is provide a carrying bag to ease transporting the portable illuminating real estate sign and accompanying post.

Yet another advantage of the invention is to provide an increase in calls from potential buyers and homeowners wanting to do business with the company named on the sign which is visible through the side of the carrying bag while in transit to the property where the sign will be erected.

### BRIEF DESCRIPTION OF THE SEVERAL VIEWS OF THE DRAWING

FIG. 1 is a side elevation view of the carrying bag in the rolling position showing one side of the contents, through the transparent portion.

FIG. 2 shows a front and side view of perspective view of an embodiment of the illuminated sign.

FIG. 3 shows the back view of a single-sided illuminated sign.

FIG. 4 shows a schematic illustration of the electronic elements within the casing.

FIG. 5 shows a disconnected view of a post which can easily be carried in the accompanying carrying bag.

FIG. 6 shows the assembled erected sign and post positioned against a fence.

### DETAIL DESCRIPTION OF THE INVENTION

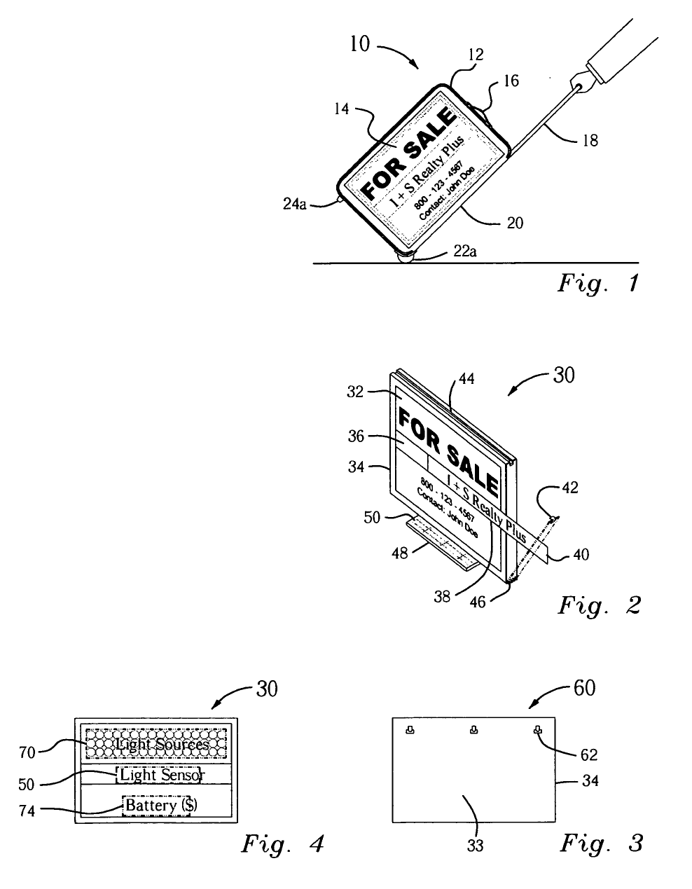

A lighting apparatus of a portable illuminating real estate sign in the form of a real estate advertising system according to the present invention will now be described in detail with reference to FIGS. 1 through 6 of the accompanying drawings. Referring to drawing FIG. 1, a carrying bag (10) is, by way of example, a roll-on, carry-on or storage type bag having a transparent plastic front portion (14), a base portion, a back portion (20), side portions, and a top portion all being constructed of a flexible solid material. The material can be made of a plastic or fabric material. A zipper (12) typically will extend around at least three of the four marginal edges, plus some of the fourth edge to permit fully folding back of the particular portion. Each zipper (12) may include a separate sliding closure guide which allows for a lock to be used once the guides meet. The bag (10) preferably includes one or more handles (16), (18) strategically placed on adjacent portion of the bag (10) to assist in pulling, handling, stacking, lifting up stairs, and the like. The carrying bag (10) also preferably includes wheels (22a), (22b) (not shown in FIG. 1) mounted near the corner opposite the handle (18) so that the bag (10) can be tipped and rolled easily by the user. A pair of legs (24a), (24b) (not shown in FIG. 1) are mounted on the same portion of the perimeter wall as the wheels (22a), (22b) preferably adjacent the opposed corner. Inside the bag (10) there may be Velcro™ fasteners to hold an illuminated real estate sign (30) and an accompanying post (80) in place.

FIG. 2 shows a portable illuminating real estate sign (30) that is double sided. The assembly of the sign (30) is significantly identical to maintain a constant appearance of the sign (30) from either front and rear views. The sign (30) has a weatherproof casing (34) made of a rigid plastic material. The casing (34) comprising: a rectangular frame or the like, consisting of a front side (32), a back side (not shown), and four edge sides all of which are joined together. Wherein said front side (32) and back side (not shown) can be made of a transparent plastic material. A solar panel (48) incorporated in said casing (34) in parallel position with respect to one or more of the four edge sides, for collecting solar energy. A light sensor (50) is next to the solar panel (48) within the casing (34), to activate the illumination of the sign (30) when conditions are cloudy or from dusk till dawn. On one side of said casing (34) is a female groove assembly (44).

On another side of said casing (34) is a hinge door (46) with a first hasp assembly (42) at the opposite end. Said door (46) could be made of a plastic or metal material. Said door (46) can be opened and closed at a 90 degree angle from a vertical to a horizontal position. Said door (46) is designed to return to a vertical position after it is opened. Within said casing (34) and behind said front side (32) is a horizontal plurality of slots (38) to support a plurality of transparency advertisements (40). While unlocked, a user can simply pull on said door (46) and slide the transparency advertisements (40) into the slot (38). Behind said slots (38) is a translucent panel (36).

Referring to FIG. 4 behind the translucent panel (36) is a circuit board consisting of at least one rechargeable battery (74) electrically connected to said solar panel (48) in a manner to recharge said battery (74) and a plurality of light sources (70). The plurality of light sources (70) being electrically connected to said battery (74) whereby to illuminate said light sources (70) to view the transparency advertisements (40) during cloudy conditions and from dusk to dawn. Whereby the plurality of light sources (70) could be bright white light emitting diodes.

FIG. 3 shows a back side (33) of a single sided illuminated sign (60). The only difference between FIG. 2 and FIG. 3 is the substitution of said back side (33) which can be made of a solid plastic material. On the back side (33) is a plurality of mounting members (62). Allowing said illuminated sign (60) to be wall mounted by nails or a thin rope passing through said members (62) to attach to a hook or nail. For example, said sign (60) can be mounted on a hook or an upper floor outside gated window.

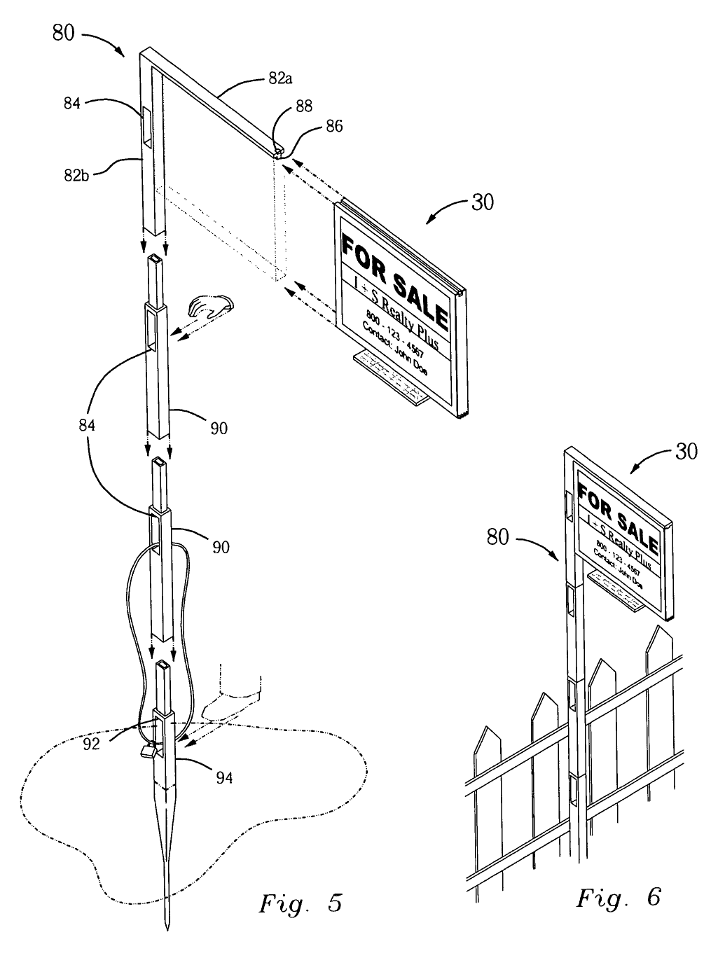

FIG. 5 depicts an unassembled view of an accompanying post (80) of predetermined lengths and sections. Said post (80) is portable and detachable designed to be weather resistant. The post (80) can be made of a light weight metal or a rigid plastic substance. The lower portion of the post (80) has a semi-hollow vertical member (94) with a ground stake shape at one end, and a male insertion at the other end, and containing at least one hole assembly (92). The hole (92) allows the user a place to apply foot pressure to drive said member (94) into the ground. There exist a plurality of a hollow vertical member (90) having a female insertion at one end and a male insertion at the other end, and containing at least one hole assembly (84). Member (94) can slidably fit into member (90). The hole (84) allows the user a place to apply hand pressure to assist in drive said member (90) combined with said member (94) into the ground. The upper section of the post (80) is a combination of a semi-hollow vertical member (82b) and a horizontal member (82a) attached at a 90 degree angle. Said member (82b) contains at least one hole (84) and female insertion that can slidably fit into said member (90). Said member (82a) consists of a male groove assembly (86). This allows the sign (30) with female groove assembly (44) to slidably fit into said member (82a). Said member (82a) consists of a second hasp assembly (88). Once the first hasp assembly (42) and the second hasp assembly (88) are facing each other at a 90 degree angle, a padlock can be used to secure the sign (30) to said member (82a) of said post (80).

FIG. 6 shows the assembled erected sign (30) and post (80) near a fence. As illustrated in FIG. 5 a chain can be used to lock the vertical members (94), (90), and (82b) in place and the post (80) can also be locked to a stationary object like a fence in FIG. 6.

Although several embodiment of the invention has been illustrated and described, it will be apparent to those skilled in the art that various changes and modifications may be made therein without departing from the spirit of the invention or from the scope of the appended claims.

What is claimed is:

1. A portable illuminated real estate sign system comprising:
a) an illuminated sign comprising a weather resistant case made of a rigid plastic material said casing consisting a rectangular frame having a front side a back side and four edge sides all of which are joined together, wherein said front side and back side is a transparent plastic material; and
b) on one side of said casing is a female groove assembly; and
c) within said casing spaced apart at a predetermine distance in parallel fashion behind said transparent front and back side is a plurality of slots made of a transparent material; and
d) said slots to support a plurality of transparency advertisements; and
e) spaced apart at a predetermine distance in parallel fashion behind said plurality of slots is a translucent panel; and
f) sandwiched between said translucent panels is a plurality of light sources to illuminate said translucent panels; and
g) a solar panel incorporated in said casing in parallel position with respect to one of the four edge sides, for collecting solar energy; and
h) a rechargeable battery electrically connected to said solar panel in a manner to recharge said battery; and said plurality of light sources being electrically connected to said battery whereby to illuminate the name plate; and
i) a light sensor within said case sensing a level of ambient light, said light sensor permitting current from said battery to energize said plurality of light sources when said sensed level of ambient light is below a predetermined level, and
j) on another side of said casing is a hinge door with a first hasp assembly at the opposite end said door can open to a 90 degree position and returns to a 90 degree resting position.

2. A single sided portable illuminated comprising:
a) a weather resistant case made of a rigid plastic material said casing consisting a rectangular frame having a front side a back side and four edge sides all of which are joined together, wherein said front side is a transparent plastic material; and
b) said back side is solid material and having a plurality of mounting members, and said mounting members, for mounting said case to a surface; and
c) on one side of said casing is a female groove assembly; and
d) within said casing spaced apart at a predetermine distance in parallel fashion behind said transparent front is a plurality of slots made of a transparent material; and
e) said slots to support a plurality of transparency advertisements; and
f) spaced apart at a predetermine distance in parallel fashion behind said plurality of slots is a translucent panel; and
g) behind said translucent panels is a plurality of light sources to illuminate said translucent panel; and
h) a solar panel incorporated in said casing in parallel position with respect to one of the four edge sides, for collecting solar energy; and
h) a rechargeable battery electrically connected to said solar panel in a manner to recharge said battery; and said plurality of light sources being electrically connected to said battery whereby to illuminate the name plate; and
i) a light sensor within said case sensing a level of ambient light, said light sensor permitting current from said battery to energize said plurality of light sources when said sensed level of ambient light is below a predetermined level, and
j) on another side of said casing is a hinge door with a first hasp assembly at the opposite end said door can open to a 90 degree position and returns to a 90 degree resting position.

3. The illuminated sign of claim 1 and 2, whereby said the plurality of light sources are bright white light emitting diodes.

4. A portable and detachable post comprising:
a) a plurality of support members having coupling means whereby said members can be connected in series to form a real estate standard consisting: a semi-hollow vertical member with a ground stake shape at one end, and a male insertion at the other end, and containing at least a hole assembly and said hole assembly allows the user a place to apply foot pressure to drive said member into the ground; and
b) a plurality of hollow vertical member having a female insertion at one end and a male insertion at the other end, and containing at least one hole assembly, member can slidably fit into said semi-hollow vertical member, said hole allows the user a place to apply hand pressure to assist in driving said hollow vertical member combined with said semi-hollow vertical member into the ground; and
c) a upper section of the post is a combination of a semi-hollow vertical member and a horizontal member attached at a 90 degree angle, said semi-hollow vertical member contains at least one hole and female insertion that can slidably fit into said hollow vertical member, said horizontal member consists of a male groove assembly, this allows said casing with said female groove assembly to slidably fit into said horizontal member, said horizontal member consists of a second hasp assembly, once the first hasp assembly and the second hasp assembly are facing each other at a 90 degree angle, a padlock can be used to secure the casing to said horizontal member.

5. A carrying bag comprising:
a bag member, said bag member having a base portion, transparent plastic front portion, back, and side portions and a top portion, all being constructed of flexible material, said bag member having a closure mechanism proximate to said top portion, and further being provided with handles proximate to the top portion of said bag member, and an adjustable handle proximate to the back portion of said bag member.
